(19) United States
(12) Patent Application Publication
(10) Pub. No.: US 2025/0355624 A1
(43) Pub. Date: Nov. 20, 2025

(54) REPRODUCIBLE STOCHASTIC ROUNDING FOR IN-NETWORK COMPUTING

(71) Applicant: MELLANOX TECHNOLOGIES, LTD., Yokneam (IL)

(72) Inventors: Yishai Oltchik, Haifa (IL); Itamar Rabenstein, Petach-Tiqwa (IL); Gil Bloch, Zichron Ya'acov (IL); Roee Levy Leshem, Tel-Aviv (IL); Daniel Segalovich, Ramat Gan (IL)

(21) Appl. No.: 18/668,792

(22) Filed: May 20, 2024

(51) Int. Cl. G06F 7/499; G06F 7/483

(52) U.S. Cl. CPC G06F 7/49947; G06F 7/483

(57) ABSTRACT

A system includes at least one processing node to perform one or more compute processes as part of a distributed workload to generate an output. The at least one processing node is configured with a derived seed value that is generated from a base seed value. The system further includes a rounding circuit to perform rounding operations for the at least one processing node according to the derived seed value.

### FIELD OF THE DISCLOSURE

The present disclosure is generally directed toward reproducible stochastic rounding for in-network computing operations, such as reduction and/or arithmetic operations.

### BACKGROUND

Switches and similar network devices represent a core component of many communication, security, and computing networks. Switches are often used to connect multiple devices to form networks. In some cases, switches have an in-network computing mode that enables certain computing functions, such as data reduction operations, to be performed by the switches themselves.

### BRIEF SUMMARY

In an illustrative example, a system comprises at least one processing node to perform one or more compute processes as part of a distributed workload to generate an output. The at least one processing node is configured with a derived seed value that is generated from a base seed value. The system further comprises a rounding circuit to perform rounding operations for the at least one processing node according to the derived seed value.

In another illustrative example, a processing node comprises a compute circuit to perform one or more compute processes as part of a distributed workload to generate an output, and a rounding circuit that cooperates with the compute circuit to perform stochastic rounding operations on the output according to a seed value.

In yet another illustrative example, a method comprises configuring ports of a processing node with a plurality of seed values generated from a base seed value, and providing reproducible stochastic rounding operations for the processing node based on the plurality of seed values.

The rounding approaches depicted and described herein may be applied to a switch, a router, or any other suitable type of networking device or general computing device known or yet to be developed. Additional features and advantages are described herein and will be apparent from the following description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a system in accordance with at least some embodiments of the present disclosure;

FIG. 2 is a block diagram depicting an example structure for a switch in accordance with at least some embodiments of the present disclosure;

FIG. 3 is a flow diagram depicting method in accordance with at least some embodiments of the present disclosure;

FIG. 4 is a flow diagram depicting another method in accordance with at least some embodiments of the present disclosure;

FIG. 5 is a flow diagram depicting yet another method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Devices including but not limited to personal computers, servers, central processing units (CPUs), graphics processing units (GPUs), and other types of computing devices, may be interconnected using network devices such as switches. Such interconnected entities may form a network enabling data communication and resource sharing among the nodes. Switches and other computing devices may provide computational services, such as reduction and/or aggregation calculations, on behalf of host devices.

For example, during training of machine learning networks using in-network algorithms for reduction and aggregation, vectors of floating-point operands are added or multiplied with higher precision than the operands sent by the host. After the calculation ends, a rounding operation may be needed. Stochastic rounding is crucial for training processes and used to introduce controlled randomness, reduce bias and variance, improve generalization, and enhance robustness.

In standard rounding techniques, values are typically rounded to the nearest representable number within a certain precision. For instance, in rounding to the nearest integer, 2.3 becomes 2, and 2.5 becomes 3. This can introduce a consistent bias in one direction, especially when dealing with a large number of calculations. Other rounding techniques, such as round to nearest even (RNE) in which numbers are rounded to the nearest even number, also introduce bias which can be unacceptable for particular types of applications.

With stochastic rounding, a number is randomly rounded up or down instead of always rounding to the nearest number. The probability of the number being rounded up or down may be proportional to the distance of the number from the two nearest representable numbers. For example, a number of 2.3, may have a 30% chance of being rounded up to 3 and a 70% chance of being rounded down to 2. An advantage of stochastic rounding is that systematic bias over many rounding operations is reduced. While each individual rounding operation may introduce an error, the errors do not systematically bias upwards or downwards. Over a large number of operations, such errors tend to average out, making stochastic rounding particularly useful in iterative processes like numerical optimization and machine learning.

The present disclosure provides solutions for the following issues within the context of stochastic rounding for in-network computing: 1) seed propagation and coordination: the in-network devices propagate and coordinate the seed value(s) between them to ensure the configuration is consistent while avoiding undesirable numeric effects (e.g., numeric bias accumulation); 2) seed storage and retrieval: isolation of computational streams between different applications and/or users-for example, so that User A's operations do not alter User B's numeric results; 3) handling race conditions between endpoints or hosts, switches, and even individual ports in the network; and 4) enabling a user to receive an allocation of in-network compute resources that may differ in resource utilization compared to a previously used allocation of in-network resources but that is isomorphic to the previously used allocation (e.g., the two allocations have an equivalent reduction tree formed from different sets of resources)—this feature may be accomplished without revealing the underlying physical network topology to users of the network.

Solutions that lack the mechanisms to handle the issues above will fail in any number of the following ways: 1) the numeric bias accumulation will interfere with the computational result; 2) reproducibility will fail because the in-network compute is not isomorphic (i.e., the in-network operation is performed in a different order, and therefore the numeric results will differ with high likelihood); 3) reproducibility will fail due to race conditions between packet arrival times; and 4) multiple tenants/applications/streams will interfere with each other and lead to nonreproducible results.

In machine learning, particularly in training deep neural networks, stochastic rounding can be valuable when working with low-precision arithmetic, such as 16-bit or 8-bit floating-point numbers. Stochastic rounding helps maintain the accuracy of a model despite the reduced precision by preventing the accumulation of rounding errors that could otherwise lead to significant biases or convergence issues.

In accordance with one or more embodiments described herein, a switch may enable a diverse range of nodes, such as other switches, servers, personal computers, and other computing devices to communicate across a network. Ports of a switch may function as communication endpoints, allowing the system to manage multiple simultaneous network connections with one or more nodes. The computing system may perform one or more methods involving the stochastic rounding of results of calculations. Such stochastic rounding may, through the systems and methods described herein, be performed in a reproducible manner.

Reproducibility, the ability to consistently duplicate the results of an experiment or calculation, is a critical aspect in computational processes, such as artificial intelligence (AI) model training performed by hosts using a switch or other computing device to perform calculations. In such scenarios, reproducibility offers several benefits. For example, in AI and machine learning, validating the results helps ensure that models are accurate and reliable. Developers can more quickly work through errors occurring during training when rounding results are reproducible. Reproducibility aids in identifying and rectifying errors in AI calculations. For example, if results can be consistently reproduced, it becomes easier to pinpoint where and why errors occur, whether in the data, algorithm, or implementation.

Conventional methods of stochastic rounding do not provide for reproducibility. Reproducibility of stochastic rounding is needed to allow users to maintain snapshots and perform debugging with the exact same training process and to ensure that the same sequence of random decisions will be generated every time.

The present disclosure describes systems and methods for enabling a switch or other computing system to perform calculations (e.g., reduction calculations) on numbers received from, for example, one or more hosts. In some examples, the system generates different seed values from a base seed value so that the seed values are functionally dependent on one another. Each switch in a network of switches may be configured with one of the different seed values and that is used to stochastically round the results of the calculations (e.g., data reduction calculations for an in-network compute operation). Notably, example embodiments enable reproducible stochastic rounding within the context of in-network computing (e.g., implemented by NVIDIA's Scalable Hierarchical Aggregation Protocol (SHARP) technology).

While the examples provided herein refer to FP16 and FP32, it should be appreciated that implementations described herein may be used for any format of number, including, for example, IEEE half-and/or single-precision floating point numbers. For example, the present disclosure may also apply to non-IEEE floating point formats, such as Bfloat16 (BF16) and the like. In some embodiments, a host may send IEEE half-precision floating point numbers and a switch may compute in IEEE single-precision floating point numbers.

Referring now to the figures, various systems and methods for providing reproducible stochastic rounding will be described. The concepts of rounding depicted and described herein can be applied to the rounding of numbers resulting from reduction operations as well as rounding of any other numbers. The implementations described below relate to specific examples in which host devices utilize a switch for computational purposes and the switch returns a rounding result of the computations. However, it should be appreciated that the same or similar systems and methods may be used for a variety of other purposes, including any scenario in which a computing device seeks to round a number.

The term data as used herein should be construed to mean any suitable discrete amount of digitized information. The data being received by the switch or other device may be in the form of packetized or non-packetized data without departing from the scope of the present disclosure. Furthermore, certain embodiments will be described in connection with a system that is configured to receive data from hosts and perform a reduction of the received data. It should be appreciated, however, that in certain implementations of the disclosed systems and methods, no hosts may be required. It should be appreciated that the features and functions of the systems and methods described herein may be utilized in a centralized architecture, a distributed architecture, or within a single computing device.

As described in more detail below, inventive concepts provide reproducible stochastic rounding operations within the context of in-network computing (e.g., using SHARP technology) through the use of seed-based pseudo random algorithms. At least one embodiment is related to propagating the seed values throughout the nodes (e.g., switches) of the network. The seed values may be derived from an initial or base seed value so that all seed values are functionally dependent on one another. At least one embodiment is related to how the seed values are stored (e.g., in a dedicated switch memory) and retrieved, such as in response to a trigger such as a user command or in response to a node entering into an in-network compute operation. At least one further embodiment relates to allocating computing resources to users of an in-network compute operation without revealing the topology of the network while doing so in a manner that adheres to strict and complex topological restrictions.

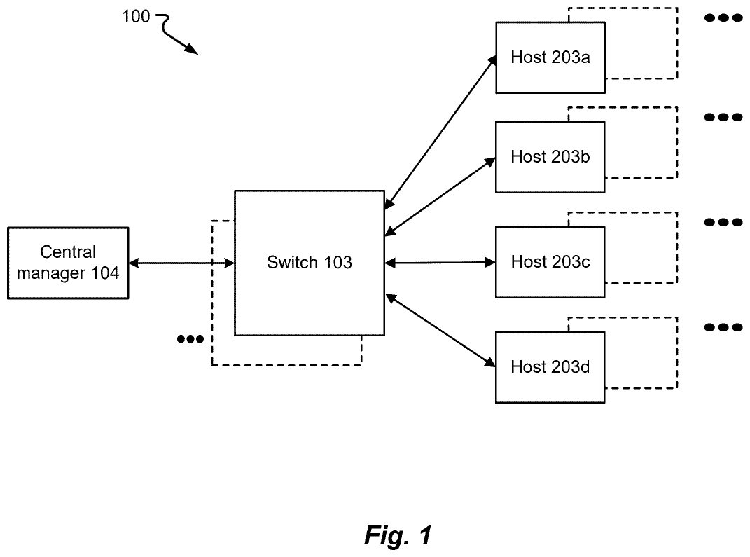

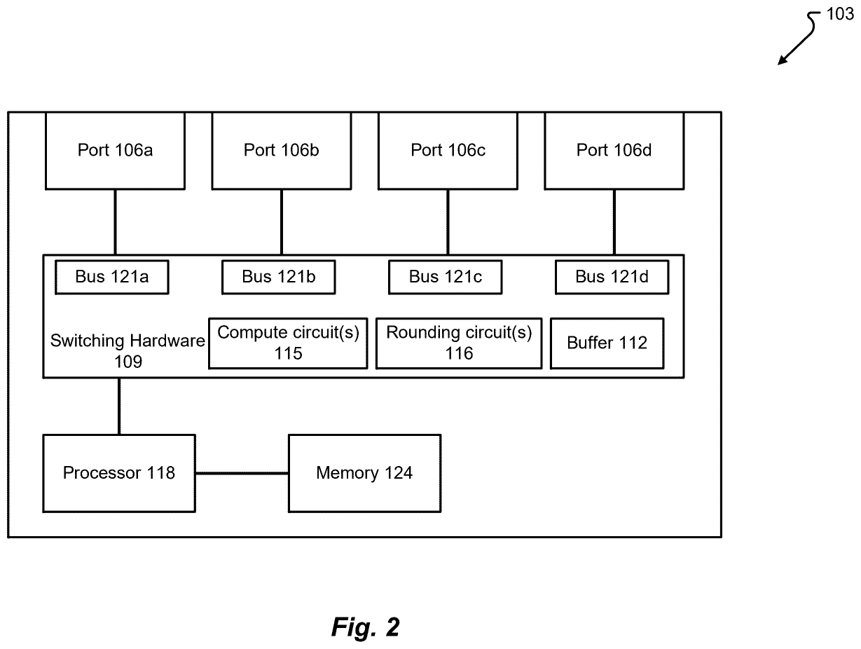

FIG. 1 illustrates a system 100 including one or more switches 103, a central manager 104, and one or more hosts 203a-d. FIG. 2 illustrates an example structure for a switch 103 (also referred to herein as a processing node).

With reference to FIGS. 1 and 2, the switch 103 may be part of a network in which a plurality of switches 103 are in communication with one another, a plurality of hosts 203a-d via ports 106a-d, and/or a central manager 104. Such a network of switch-connected hosts may be useful in various settings, from data centers and cloud computing infrastructures to artificial intelligence systems.

A switch 103 may be or include, for example, a network switch, a network interface controller (NIC), or other device capable of receiving and routing data to other nodes in the network. Switches 103 may be connected in a suitable topology (e.g., a fat tree topology) that includes top-of-rack (TOR) or core switches, spine switches, and/or leaf switches, for example. Switches 103 may be capable of receiving, processing, and forwarding data, e.g., packets, to appropriate destinations within the network, such as other switches 103 and/or hosts 203. In some implementations, a switch 103 may be included in a switch box, a platform, or a case which may contain one or more switches 103 as well as one or more power supply devices and other components.

Each host 203 may be a computing unit, such as a personal computer, server, or other computing device, and may be responsible for executing applications and performing data processing tasks. Hosts 203 as described herein may range from servers in a data center to desktop computers in a network, or to devices such as internet of things (IoT) sensors and smart devices, as examples. A host 203 may be or include a Host Channel Adapter (HCA). Each host 203 may include one or more processing circuits, such as GPUs, CPUs, ASICs, FPGAs, or other circuitry capable of performing computations, as well as memory and storage resources to run software applications, handle data processing, and perform specific tasks as required. In some implementations, hosts 203 may also or alternatively include hardware such as GPUs for handling intensive tasks for machine learning, artificial intelligence (AI) workloads, or other complex processes. The hosts 203a-d may, for example, utilize computational capabilities of the switch 103 to aggregate data to derive a single result, such as through summing, finding minimum or maximum values, or combining data sets. The data sent from the hosts 203a-d to the switch 103 may be raw data which the switch 103 may reduce.

The central manager 104 may manage one or more aspects on behalf of the system 100. The central manager 104 may have processing capabilities and be implemented by a server or other suitable computing device. Alternatively, the central manager 104 is implemented within or by one or more of the switches 103. In some examples, the central manager 104 is responsible for generating or deriving seed values (for use by rounding operations within switches 103) from a base seed value. The base seed value may be provided by a host 203 (e.g., by a user of an application running at a host 203). In at least one embodiment, the central manager 104 is responsible for encrypting a message that is indicative of an allocation computing resources which are made available to an application for executing a distributed workload. The encrypted message may further contain a description of the allocation's characteristics that must replicated for the particular application, such as reduction topology criteria that define the topology of a reduction tree used for the application (where a “reduction tree” refers to the nodes at which reduction operations are performed for a distributed workload). The encrypted message may be sent to the application or user of the application and remain encrypted so as not to reveal the topology of the reduction tree to the application or user of the application. Although not explicitly shown, the central manager 104 may be in communication with other unillustrated elements of the system 100 (e.g., a job scheduler).

In some examples, hosts 203 and switches 103 operate as a high-performance computing (HPC) cluster. A cluster of hosts 203 may comprise numerous interconnected servers, each equipped with CPUs and/or GPUs. The hosts 203 may provide computational horsepower for, as an example, training large-scale AI models or running complex scientific simulations. For Al and machine learning tasks, the hosts 203 may comprise one or more GPUs or other processing circuitry which may be capable of handling parallel processing requirements of neural networks and other applications. Hosts 203 may engage in AI-related, research-related, and other processor-intensive tasks, and utilize a network of switches 103 and other hosts 203 to handle distributed computational loads. Such hosts 203 may include, for example, workstations and personal computers used by researchers, data scientists, and professionals for developing, testing, and running AI models and research simulations.

In some implementations, a switch 103 is capable of providing computational capabilities and performing calculations on behalf of one or more hosts 203. For example, a switch 103 may perform one or more in-network compute processes as part of a distributed workload to generate an output. The distributed workload may correspond to a machine learning operation or other computing operation that involves multiple computing resources (e.g., hosts) processing a large workload in parallel.

Data may flow through the network of switches 103 and hosts 203 using one or more protocols such as transmission control protocol (TCP), user datagram protocol (UDP), or Internet protocol (IP), for example. A switch 103 may, upon receiving data from a host 203 or another switch 103 examine the data to identify a computation required for the data, perform the computation, round a result of the computation, and route the rounded result of the computation as data through the network.

With reference to FIG. 2, a switch 103 may include a plurality of ports 106a-d, busses 121a-d, switching hardware 109, buffer(s) 112, one or more compute circuits 115, processor(s) 118, and memory 124. The ports 106a-d of a switch 103 may be capable of facilitating the transmission of data packets, or non-packetized data, into, out of, and through the switch 103. Such ports 106a-d may serve as interface points where network cables are connected, connecting the switch 103 with other switches 103, and/or hosts 203.

Each port 106 may be capable of receiving incoming data packets from other devices and/or transmitting outgoing data packets to other devices. In some implementations, ports 106 may be configured to operate as either dedicated ingress or egress ports 106 or may be enabled to operate in a dual functionality capable of performing ingress and egress functions. For example, an egress port 106 may be used exclusively for sending data from the switch 103 and an ingress port 106 may be used solely for receiving incoming data into the switch 103.

Switching hardware 109 of a switch 103 may be capable of handling a received packet by performing ingress processing, reduction calculations, generating a number based on a seed value, using the generated number to round a result of the reduction calculations, and performing egress processing of the rounded result of the reduction calculations. Using a system or method as described herein, switching hardware 109 may be capable of providing reduction computation capabilities for one or more hosts 203 using stochastic rounding in a reproducible manner.

Each port 106a-d of a switch 103 may be associated with one or more buses 121a-d. When data, such as a vector, a stream of numbers, or data in any format, is received via a port 106a-d, the data may be stored in a respective bus 121a-d associated with the port 106a-d. The data, in the form of numbers, appearing on the bus(es) may be used both for reduction computations as well as the generation of numbers to be used to round the results of the reduction computations.

One or more compute circuits 115 may enable the switch 103 to perform computational tasks. Such tasks may range from simple arithmetic calculations to more complex logical decision-making processes. Compute circuit(s) 115 as described herein may be capable of performing a variety of arithmetic operations such as addition and/or subtraction as well as logic operations (such as AND, OR, NOT, etc.). The compute circuit(s) 115 may include one or more arithmetic logic units (ALUs), central processing units (CPUs), graphics processing units (GPUs), application-specific integrated circuits (ASICs), and/or field programmable gate arrays (FPGAs) to handle computational tasks for hosts 203.

According to embodiments of the present disclosure, hosts 203 may utilize the switches 103 to offload reduction tasks to minimize computational load and to process data more efficiently. A reduction task as described herein may include operations such as summing values, finding minimum or maximum values, or combining data sets. Example reduction operations include Reduce, AllReduce, ReduceScatter, BlockedReducedScatter, and/or the like. Stated another way, the switches 103 may operate in an in-network compute mode and be capable of in-network compute operations, for example, in accordance with NVIDIA's SHARP technology, which has been introduced to greatly decrease the latency of reduction operations. In particular, SHARP defines a protocol for reduction operations that are performed on data as the data traverses a reduction tree in the network. This enables manipulation of data while transferred within the data center network instead of waiting for the data to reach a central CPU. Each switch 103 may utilize its compute circuit(s) 115 to perform one or more of the above-mentioned reduction operations upon receiving data from one or more hosts 203. The result of the operations may, as described above, utilize rounding performed by one or more rounding circuits 116. In such a scenario, the switch 103 may be configured, using one or more rounding circuits 116, to perform a rounding operation, such as stochastic rounding of the result of the compute operation and return the rounded result to one or more other nodes of the network, such as the hosts 203. The rounded result can be reproduced in later iterations and thereby reducing rounding bias that may conflict with results of computationally heavy tasks such as the training of AI models.

The operation performed by the compute circuit(s) 115 may be a floating point operation. For example, the bus(es) 121 may receive one or more vectors containing multiple floating point numbers. To perform the operation, the compute circuit(s) 115 may convert each floating point number into a floating point number with a higher precision. This conversion may enable the compute circuit(s) 115 to accurately perform the operation and minimize error during the operation. Once the numbers are in a higher precision floating point format, the compute circuit(s) 115 may perform the floating point operation, such as an addition or multiplication operation. As an example, the compute circuit(s) 115 may iteratively add each higher precision floating point number to an accumulator.

After performing the floating point operation, the compute circuit(s) 115 may output the result to rounding circuit(s) 116 to round the higher precision floating point result back to a lower precision floating point number. The rounding circuit(s) 116 may perform stochastic rounding using a seed value that is generated from a base seed value. Seed-based stochastic rounding is described in more detail below, but should generally be understood as a form of stochastic rounding that is enhanced with an initial value called a seed.

Although the compute circuit(s) 115 and the rounding circuit(s) 116 are shown as separate circuits, these elements may be processes executed by a single unit such as an ALU.

One or more processors 118 may be configured to control aspects of the switching hardware 109. A processor 118 may in some implementations include a CPU, an ASIC, and/or other processing circuitry which may be capable of handling computations, decision-making, and management functions for operation of the switch 103. A processor 118 may be configured to handle management and control functions of the switch 103, such as setting up routing tables, configuring ports, and otherwise managing operation of the switch 103. A processor 118 of the switch may execute software and/or firmware to configure and manage the switch 103, such as an operating system and management tools.

Memory 124 of a switch 103 as described herein may comprise one or more memory elements capable of storing configuration settings, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

Example embodiments will now be described with reference to various methods that enable reproducible stochastic rounding to be performed in the context of in-network compute operations by switches 103. The stochastic rounding discussed herein is said to be reproducible in that it is possible to perform stochastic rounding on the same values (e.g., floating point values) at different times while obtaining the same result each time.

Example embodiments relate to implementing stochastic rounding in an in-network compute environment to create a system that is reliable, useful, and practical to use and integrate. The present disclosure provides solutions for the following issues within the context of stochastic rounding for in-network computing: 1) seed propagation and coordination: the in-network devices propagate and coordinate the seed value(s) between them to ensure the configuration is consistent while avoiding or reducing undesirable numeric effects (e.g., numeric bias accumulation); 2) seed storage and retrieval: isolation of computational streams between different applications and/or users-for example, so that User A's operations do not alter User B's numeric results; 3) handling race conditions between endpoints, switches, and even individual ports in the network; and 4) enabling a user to receive an allocation of in-network compute resources that may differ in resource utilization compared to a previously used allocation of in-network resources but that is isomorphic to the previously used allocation (e.g., the two allocations have an equivalent reduction tree formed from different sets of resources)—this feature may be accomplished without revealing the underlying physical network topology to users of the network.

With reference to issue 1 above (seed propagation and coordination), while all participating endpoints may send their initial seed into the in-network compute tree, only one designated endpoint's seed is used as a base seed value. All other seed values are derived from that base seed value and are spread internally into the in-network compute tree as part of a configuration step. As a result, the seed values are functionally dependent on one another to allow for reproducibility while permitting each port to have a different seed value to overcome the numeric bias accumulation problem.

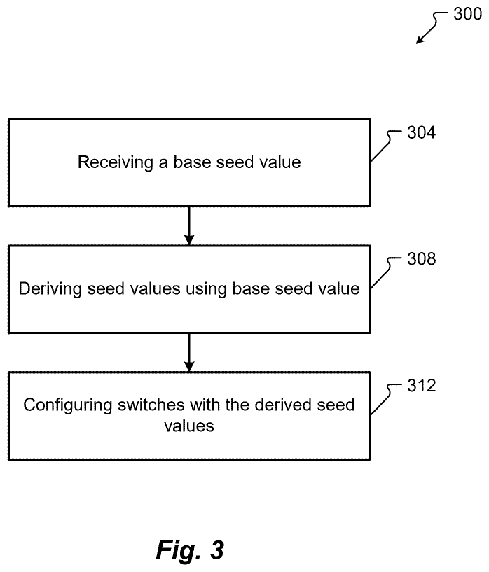

FIG. 3 illustrates a method 300 for seed propagation and coordination according to at least one embodiment. The method 300 may be performed by one or more of the elements described herein, such as a switch 103, the central manager 104, and/or a host 203.

Operation 304 comprises receiving a base seed value. The base seed value may be provided by a user of the system 100, such as by a user of an application at a host 203. The base seed value may be requested from the host 203 in response to the host's request for the system 100 to process a distributed workload to generate output on which stochastic rounding is performed. The base seed value may comprise a user-defined number, such as a real number (e.g., an integer), which may be expressed in bits (FP16, FP32, etc.).

Operation 308 comprises generating or deriving seed values from the base seed value. In some examples, seed values are generated or derived from the base seed values by using the base seed value as an input to an algorithm. Output of the algorithm may include a first derived seed value that is different than the base seed value. The first derived seed value may then serve as input to the same algorithm to generate a second derived seed value that is different than the first derived seed value and the base seed value. This sequence of using a previously derived seed value as input for the algorithm to generate another derived seed value may continue until enough derived seed values have been generated. As may be appreciated, each derived seed value is different from the other derived seed values but all derived seed values are functionally related to one another, which enables reproducibility for reduction operations at the switches 103 while avoiding the numeric bias problem. Output of the algorithm that generates derived seed values from the base seed value may also include an indicator as to whether each derived seed value is associated with a round up operation or a round down operation in a stochastic rounding operation. In some examples, the derived seed values are indicative of a probability of rounding up or rounding down in a stochastic rounding operation.

Operation 312 includes configuring the switches 103 with the derived seed values. For example, the derived seed values from operation 308 may be propagated throughout the network of switches 103 such that each port 106 of each switch 103 is assigned or associated with one of the derived seed values. Upon completion of configuration, each port 106 of each switch 103 involved in the reduction operation may have a different derived seed value. As may be appreciated then, operation 308 may including counting the number of switch ports available for use by the application so that a correct number of derived seed values are generated.

Here, it should be understood that the method 300 may be carried out separately for separate applications so that a different set of derived seed values is generated for each application, which may avoid interference between applications.

With reference to issue 2 above (seed value storage and retrieval), there may be two different solutions, and each solution is suited for different switch hardware. The first solution uses a dedicated lookup mechanism inside the switch's firmware memory that stores derived seed values. Whenever the in-network compute functionality is used for a given workload, the derived seed values are pulled from the memory and onto the relevant arithmetic units of the switches 103. This may be done explicitly with the user (host 203) issuing a “load-seed” command. Only after the command succeeds are compute packets sent to the switches 103. Alternatively, the switch firmware automatically loads the correct seed values by searching its memory. The second solution incorporates the seed values into a “priming” mechanism of the in-network compute devices (switches 103). For example, when priming or preparing in-network compute resources for use by a first workload, the seed values for the first workload are spread onto the ports 106 as part of a configuration process (e.g., seed values are generated according method 300 and/or already stored seed values for the first workload are sent by hosts 203 to ports 106). If the first workload is temporarily paused and the in-network compute resources are made available for use by other workloads, the seed values for the paused first workload are returned to the endpoints (hosts 203) and maintained or stored for later use in case of resumption of the first workload when the seed values would be spread back onto ports 106 in the configuration process.

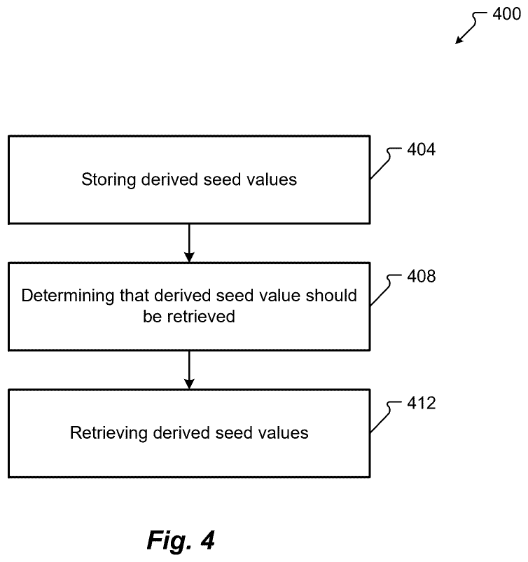

FIG. 4 illustrates a method 400 for seed storage and retrieval according to at least one embodiment. The method 400 may be performed by one or more of the elements described herein, such as a switch 103, the central manager 104, and/or a host 203.

Operation 404 may include storing the derived seed values generated during execution of the method 300 described above. For example, the specific progression of derived seed values obtained through the algorithm mentioned in operation 308 may be stored for a particular workload (or stream) so as to enable retrieval of those derived seed values in the event of a pause or interruption of the workload. Storing the progression of derived seed values may involve maintaining an ordered list of the derived seed values in memory (e.g., buffer 112, memory 124) to ensure that the ports 106 are configured with the same derived seed values before workload stoppage and after workload resumption. The ordered list of derived seed values may be stored in a manner that also indicates the derived seed values are for use with a particular workload so as to avoid interference with seed values used for other workloads.

Operation 408 includes determining that that the derived seed values should be retrieved. Operation 408 may include, for example, detecting that a stopped workload is resuming, which may occur automatically if, for example, the workload is queued for resumption. In some examples, detecting that a stopped workload is resuming may occur in response to a request from the application to resume the workload.

Operation 412 includes retrieving the derived seed values as stored in operation 404. Operation 412 may occur automatically in response to operation 408. That is, retrieving the derived seed values may occur in response to determining that a stopped workload is resuming. The derived seed values may be retrieved according to capabilities of the system. One solution involves using switch 103 firmware, such as a low level communication library that retrieves derived seed values for the particular workload from memory, unloads seed values from ports 106 used for the previous workload, and loads derived seed values for the resumed workload to ports 106. Here, the system waits for responses indicating that seed value propagation is complete prior to resuming the workload. Another solution involves building the retrieval function into dedicated hardware (e.g., the compute circuit 115) for reduction operations. In this case, operation 412 may include automatically loading derived seed values that belong the resumed workload from scratchpad memory as part of the configuration process for resuming the workload.

With reference to issue 3 above (race conditions), the in-network compute is performed in a way that is numerically equivalent to using a fixed summation order on all operands regardless of their respective arrival times. This may be accomplished mathematically, such as by using higher-precision internal representations.

With reference to issue 4 above (in-network compute isomorphism), when the user requests an in-network compute allocation, the user receives an encrypted string from the system (e.g., the central manager 104). The encrypted string can be decrypted only by the in-network compute's central manager 104. If sent by the user at a future date, the central manager 104 will be able to determine the topological structure of the in-network compute allocation (height of the tree, in-degree of each vertex, etc.) and assign resources to the user accordingly. Because the string is encrypted, the user is not exposed to the precise topology of the tree or the underlying network.

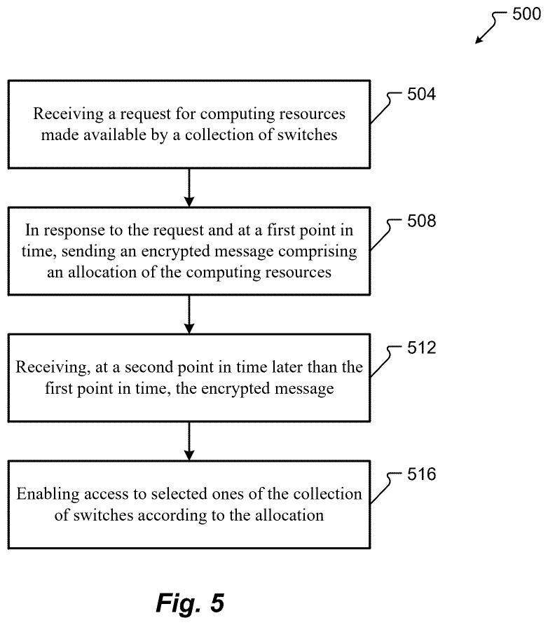

FIG. 5 illustrates a method 500 for maintaining in-network compute isomorphism according to at least one embodiment. The method 500 may be performed by one or more of the elements described herein, such as the central manager 104.

Operation 504 includes receiving a request for in-network computing resources made available by a collection of switches 103. The request may be sent by a user of a particular application to the central manager 104. The request for in-network computing resources may be a request for resources to perform an in-network compute operation for the particular application. Responsive to the request, the central manager 104 may allocate in-network computing resources for the particular application. The allocation may be defined by characteristics that must be replicated for processing the application's workload. As such, the encrypted message may include a description of the topology of a reduction tree, which is a logical tree for performing reduction operations at the switches 103. For example, the encrypted message may include a description of reduction topology criteria associated with the allocation, such as the height of the tree, in-degree of each vertex, and/or the like.

Operation 508 includes, in response to the request and at a first point in time, generating and sending an encrypted message comprising the allocation of the in-network computing resources. The encrypted message may include the description of the topology of the allocated in-network computing resources, such as the height of the tree, in-degree of each vertex, and/or the like. The message may be encrypted and sent by the central manager 104 to the requesting application where the encrypted message is stored or maintained. Notably, encrypted message cannot be decrypted by the application. Instead, the central manager 104 may be the only entity capable of decrypting the encrypted message. As such, the topology of the reduction tree is not revealed to the user/applications, which is a notable feature of the method.

Operation 512 includes receiving, at a second point in time later than the first point in time, the encrypted message. For example, the central manager 104 may receive the encrypted message from the application when the application desires to use the previously allocated in-network computing resources and sends the encrypted message back to the central manager 104.

Thereafter, operation 516 includes enabling access to selected ones of the collection of switches 103 according to the allocation. For example, in operation 516, the central manager 104 decrypts the encrypted message received from the application and determines the assigned reduction topology from the decrypted message. The central manager 104 may then select a subset of available switches 103 that meet the reduction topology criteria for the requesting application, and enable the application to use the selected switches 103 for an in-network compute operation. If the central manager 104 determines that the available switches 103 cannot meet the reduction topology criteria, then the central manager may notify the application of the same. At this point, the user can instruct the system to delay the in-network compute operation until enough switches 103 are available to meet the reduction topology criteria or, alternatively, instruct the system to proceed with the in-network compute operation knowing that the reduction topology criteria are not met. Notably, the selection of switches 103 for an in-network compute operation is flexible in that central manager 104 need not select the same subset of switches 103 in future iterations of the method 500 for a particular application. Instead, the central manager 104 may select a different subset of switches 104 in future iterations so long as the selected switches are capable of meeting the reduction topology criteria.

In view of the above, it should be appreciated that example embodiments provide for a system 100 that comprises at least one processing node that performs one or more compute processes as part of a distributed workload to generate an output. The at least one processing node may correspond to or comprise a switch 103, and the one or more compute processes may be performed as part of an in-network compute operation for the distributed workload. As described above with reference to FIG. 3, for example, the at least one processing node is configured with a derived seed value that is generated from a base seed value. As described with reference FIG. 4, the derived seed value may be retrieved from memory of the at least one processing node. In some examples, the derived seed value is retrieved from the memory in response to a trigger. In at least one embodiment, the trigger comprises a user command to load the derived seed value. In some embodiments, the trigger comprises activating in-network compute functionality for the at least one processing node. As also described above, the at least one processing node may comprise a plurality of ports 106, and each port may be configured with a different seed value. As described above with reference to FIG. 3, the different seed values may be generated using the base seed value, which may be a user-defined seed value. For example, the base seed value serves as an input to an algorithm that generates subsequent derived seed values.

In at least one embodiment, the system 100 further comprises a rounding circuit 116 to perform rounding operations for the at least one processing node according to the derived seed value. As described herein, the rounding operations may comprise stochastic rounding operations performed on floating-point values output from compute circuit(s) 115.

In at least one embodiment, the system 100 further comprises a central manager 104 in communication with the at least one processing node. The central manager 104 may perform operations described with reference to FIG. 5. For example, the central manager 104 may receive a request for in-network computing resources made available by a collection of processing nodes that includes the at least one processing node, and in response to the request and at a first point in time, send an encrypted message comprising an allocation of the in-network computing resources. As noted herein, encrypted message may comprise a description of reduction topology criteria that should be satisfied to ensure reproducibility. Thereafter, the central manager 104 may receive, at a second point in time later than the first point in time, the encrypted message, and enable access to selected ones of the collection of processing nodes according to the allocation.

In view of the above, at least one embodiment is directed to a processing node (e.g., a switch 103) that comprises a compute circuit 115 to perform one or more compute processes as part of a distributed workload to generate an output. As may be appreciated, the one or more compute processes may include a reduction operation. The processing node may further comprise a rounding circuit 116 that cooperates with the compute circuit 115 to perform stochastic rounding operations on the output according to a seed value. In accordance with embodiments of the present disclosure, the output may comprise floating-point values on which the stochastic rounding operations are performed. In addition, the seed value may be generated from a base seed value in accordance with the discussion of FIG. 3. The base seed value may be user-defined (e.g., provided by a user of an application). The processing node may further comprise a plurality of ports, with each port being configured with a different seed value that is used to perform the stochastic rounding operations.

In view of the above, at least one embodiment is directed to a method that comprises configuring ports of a processing node with a plurality of seed values generated from a base seed value. Here the processing node may correspond to a switch 103 with ports 106. Configuring the ports 106 with a plurality of seed values may be performed in accordance with the operations described with reference FIG. 3. The method may further include providing reproducible stochastic rounding operations for the processing node based on the plurality of seed values. The reproducible stochastic rounding operations may be performed on outputs of compute circuits 115 to ensure that the same results are obtained at different times.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
at least one processing node to perform one or more compute processes as part of a distributed workload to generate an output, the at least one processing node being configured with a derived seed value that is generated from a base seed value; and
a rounding circuit to perform rounding operations for the at least one processing node according to the derived seed value.

2. The system of claim 1, wherein the rounding operations are performed on floating-point values.

3. The system of claim 2, wherein the rounding operations comprise stochastic rounding operations.

4. The system of claim 1, wherein the at least one processing node comprises a plurality of ports, and wherein each port is configured with a different seed value.

5. The system of claim 4, wherein the different seed values are generated using the base seed value.

6. The system of claim 1, wherein the derived seed value is retrieved from memory of the at least one processing node.

7. The system of claim 6, wherein the derived seed value is retrieved from the memory in response to a trigger.

8. The system of claim 7, wherein the trigger comprises a user command to load the derived seed value.

9. The system of claim 7, wherein the trigger comprises activating in-network compute functionality for the at least one processing node.

10. The system of claim 1, further comprising:
a central manager in communication with the at least one processing node, the central manager being configured to:
receive a request for in-network computing resources made available by a collection of processing nodes that includes the at least one processing node; and
in response to the request and at a first point in time, send an encrypted message comprising an allocation of the in-network computing resources, the encrypted message comprising a description of reduction topology criteria associated with the allocation.

11. The system of claim 10, wherein the central manager is configured to:
receive, at a second point in time later than the first point in time, the encrypted message; and
enable access to selected ones of the collection of processing nodes according to the allocation.

12. The system of claim 1, wherein the at least one processing node comprises a network switch.

13. The system of claim 1, wherein the one or more compute processes are performed as part of an in-network compute operation for the distributed workload.

14. A processing node, comprising:
a compute circuit to perform one or more compute processes as part of a distributed workload to generate an output; and
a rounding circuit that cooperates with the compute circuit to perform stochastic rounding operations on the output according to a seed value.

15. The processing node of claim 14, wherein the output comprises floating-point values on which the stochastic rounding operations are performed.

16. The processing node of claim 14, wherein the seed value is generated from a base seed value.

17. The processing node of claim 16, wherein the base seed value is user-defined.

18. The processing node of claim 14, further comprising:
a plurality of ports, wherein each port is configured with a different seed value that is used to perform the stochastic rounding operations.

19. The processing node of claim 14, wherein the one or more compute processes comprises a reduction operation.

20. A method, comprising:
configuring ports of a processing node with a plurality of seed values generated from a base seed value; and
providing reproducible stochastic rounding operations for the processing node based on the plurality of seed values.
